(19) United States
(12) Patent Application Publication
(10) Pub. No.: US 2022/0101620 A1
(43) Pub. Date: Mar. 31, 2022

(54) METHOD AND APPARATUS FOR INTERACTIVE DISPLAY OF IMAGE POSITIONING, ELECTRONIC DEVICE AND STORAGE MEDIUM

(71) Applicant: BEIJING SENSETIME TECHNOLOGY DEVELOPMENT CO., LTD., Beijing (CN)

(72) Inventor: Liwei ZHANG, Beijing (CN)

(21) Appl. No.: 17/547,286

(22) Filed: Dec. 10, 2021

Related U.S. Application Data
(63) Continuation of application No. PCT/CN2020/100928, filed on Jul. 8, 2020.

(30) Foreign Application Priority Data
Nov. 29, 2019 (CN) 201911203808.9

(51) Int. Cl. G06T 19/20; G06V 10/40; G06V 20/64; G06V 10/94

(52) U.S. Cl. CPC G06T 19/20; G06V 10/40; G06T 2200/24; G06V 10/95; G06T 2219/2016; G06V 20/64

(57) ABSTRACT

A method for interactive display of image positioning includes: a positioning point is obtained in response to a selection operation of a target object; an interactive object displayed at a position corresponding to the positioning point in each of a plurality of operation areas is obtained according to correspondence relationships between the plurality of operating areas with respect to the positioning point.

### CROSS-REFERENCE TO RELATED APPLICATIONS

This application is a continuation of International Application No. PCT/CN2020/100928, filed on Jul. 8, 2020, which claims priority to Chinese Patent Application No. 201911203808.9, filed on Nov. 29, 2019. The disclosures of International Application No. PCT/CN2020/100928 and Chinese Patent Application No. 201911203808.9 are hereby incorporated by reference in their entireties.

### BACKGROUND

During 2D (two-dimensional) planar display and 3D (three-dimensional) stereo model modeling, for target objects and positioning points in different operation areas (2D display areas, or 3D display areas obtained through 3D stereo model modeling), it is necessary to feed back the spatial positioning of the target objects and the positioning points in a plurality of operation areas to the user for viewing. However, in the related art, the display mode of the spatial positioning is not intuitive, so that the user cannot obtain the display feedback of the spatial positioning in time.

### SUMMARY

Embodiments of the present disclosure relate to the technical field of spatial positioning, and in particularly to a method and apparatus for interactive display of image positioning, an electronic device, and a storage medium.

Embodiments of the present disclosure provide a method and apparatus for interactive display of image positioning, an electronic device, and a storage medium.

The technical solutions of the embodiments of the present disclosure are implemented as follows.

An embodiment of the present disclosure provides a method for interactive display of image positioning, the method including: obtaining a positioning point in response to a selection operation of a target object; and obtaining an interactive object displayed at a position corresponding to the positioning point in each of a plurality of operation areas according to correspondence relationships between the plurality of operating areas with respect to the positioning point.

An embodiment of the present disclosure provides a device for interactive display of image positioning, including a memory storing processor-executable instructions, and a processor. The processor is configured to execute the stored processor-executable instructions to perform operations of: obtaining a positioning point in response to a selection operation of a target object; and obtaining an interactive object displayed at a corresponding position of the positioning point in each of a plurality of operation areas according to the correspondence relationships between the plurality of operating areas with respect to the positioning point.

An embodiment of the present disclosure provides a non-transitory computer storage medium having stored thereon computer-readable instructions that, when executed by a processor, cause the processor to perform operations of a method for interactive display of image positioning, the method including: obtaining a positioning point in response to a selection operation of a target object; and obtaining an interactive object displayed at a position corresponding to the positioning point in each of a plurality of operation areas according to correspondence relationships between the plurality of operation areas with respect to the positioning point.

It is to be understood that the above general descriptions and detailed descriptions below are only exemplary and explanatory and not intended to limit the embodiments of the disclosure.

According to the following detailed description on the exemplary embodiments with reference to the accompanying drawings, other characteristics and aspects of the embodiments of the disclosure become apparent.

### BRIEF DESCRIPTION OF THE DRAWINGS

The accompanying drawings, which are incorporated in and constitute a part of this specification, illustrate embodiments consistent with the disclosure and, together with the description, serve to explain the technical solution in the embodiments of the disclosure .

FIG. 1 is a flowchart of a method for interactive display of image positioning according to an embodiment of the present disclosure;

FIG. 2 is a schematic diagram of an positioning point on a target object according to an embodiment of the present disclosure;

FIG. 3 is a schematic diagram of spatial positioning that is matching from one another according to an embodiment of the present disclosure;

FIG. 4 and FIG. 5 are schematic diagrams of interactive objects displayed at different positions in operation areas according to an embodiment of the present disclosure;

FIG. 6 is a partially enlarged schematic diagram of an interactive object in the shape of a flat cylinder according to an embodiment of the present disclosure;

FIG. 7 is a schematic diagram showing a change in shape of an interactive object that is a flat cylinder according to an embodiment of the present disclosure;

FIG. 8 is a block diagram of a device for interactive display of image positioning according to an embodiment of the present disclosure;

FIG. 9 is a block diagram of an electronic device according to an embodiment of the present disclosure;

FIG. 10 is a block diagram of an electronic device according to an embodiment of the present disclosure.

### DETAILED DESCRIPTION

Various exemplary embodiments, features, and aspects of the disclosure will be described in detail below with reference to the accompanying drawings. The same reference signs in the drawings represent components with the sane similar functions. Although each aspect of the embodiments is shown in the drawings, the drawings are not required to be drawn to scale, unless otherwise specified.

Herein, special term “exemplary” refers to “use as an example, embodiment or description”. Herein, any “exemplarily” described embodiment may not be explained to be superior to or better than other embodiments.

In the disclosure, term “and/or” is only an association relationship describing associated objects and represents that three relationships may exist. For example, A and/or B may represent three conditions: i.e., independent existence of A, existence of both A and B and independent existence of B. In addition, term “at least one” in the disclosure represents any one of multiple or any combination of at least two of multiple. For example, including at least one of A, B and C may represent including any one or more elements selected from a set formed by A, B and C.

In addition, for describing the embodiments of the disclosure better, many specific details are presented in the following specific implementation modes. It is understood by those skilled in the art that the disclosure may still be implemented even without some specific details. In some examples, methods, means, components and circuits known very well to those skilled in the art are not described in detail, to highlight the subject of the disclosure.

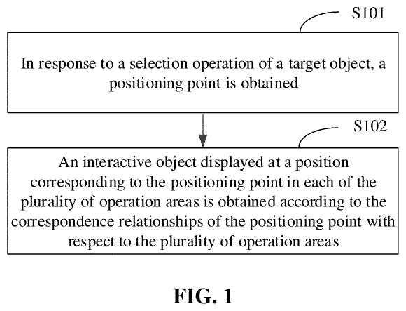

FIG. 1 shows a flowchart of a method for interactive display of image positioning. The method is applied to an interactive display device for image positioning. For example, in a case where the device is deployed in a terminal device, a server or other processing devices, spatial positioning, interactive display processing and the like may be performed. The terminal device may be a User Equipment (UE), a mobile device, a cellular telephone, a cordless telephone, a Personal Digital Assistant (PDA), a handheld device, a computing device, an in-vehicle device, a wearable device and the like. In some possible implementations, the processing method may be implemented by a processor invoking computer-readable instructions stored in a memory. As shown in FIG. 1, the process includes following operations.

In operation S101, in response to a selection operation of a target object, a positioning point is obtained.

In an embodiment, the target object may be various human body parts (e.g., sensory organs such as eyes, ears and the like, or visceral organs such as heart, liver, stomach and the like), human body tissues (e.g., epithelial tissue, muscle tissue, nerve tissue and the like), human body cells, blood vessels and the like in a medical scene.

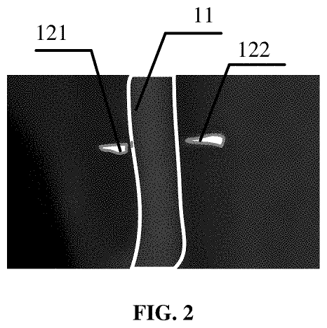

FIG. 2 shows a schematic diagram of a positioning point on a target object according to an embodiment of the present disclosure. In the case where the target object is a blood vessel 11, the positioning point may be an operation position point obtained in the case where a selection operation is performed on the blood vessel, and the position point is identified by a first positioning identification 121 and a second positioning identification 122.

In an embodiment, before obtaining the positioning point in response to a selection operation of a target object, the method further includes: obtaining a feature vector of the target object, and recognizing the target object according to the feature vector and a recognition network.

In operation S102, an interactive object displayed at a position corresponding to the positioning point in each of the plurality of operation areas is obtained according to the correspondence relationships between the plurality of operation areas with respect to the positioning point.

The interactive object may exhibit different display states as the relative positional relationship between the positioning point and the target object changes, such as a cross, a flat cylinder and the like. The relative positional relationship may include: the positioning point is located inside and outside the target object. In other embodiments, the relative positional relationship may also be subdivided, e.g., the positioning point is located at an angle, a direction and a distance outside the target object.

In an example, in the case where the plurality of operation areas represent a 2D image and a 3D image, the position corresponding to the positioning point in each of the plurality of operation areas is respectively obtained according to a correspondence relationship of the positioning point in the 2D image and the 3D image, and interactive objects interlocking between the plurality of operation areas are displayed at the positions corresponding to the positioning point in the plurality of operation areas.

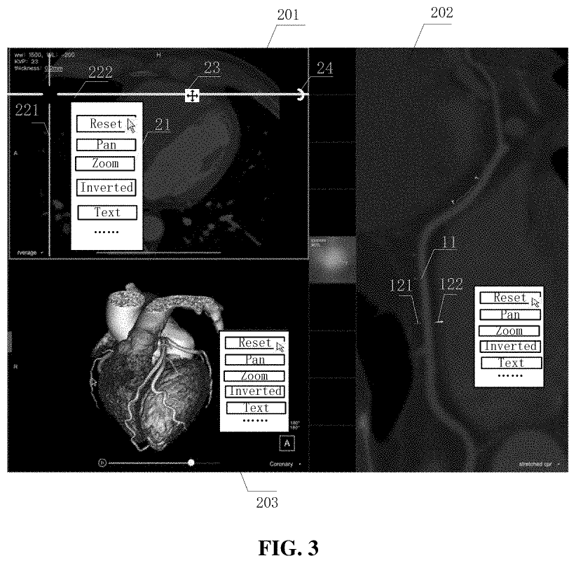

FIG. 3 shows a schematic diagram of spatial positioning that is matching from one another according to an embodiment of the present disclosure. The operation area 201 may be an original 2D image, and the operation area 202 and the operation area 203 may respectively be 3D reconstructed images. The operation area 203 may be used to display a global schematic diagram of a human body part, and the operation area 202 may be used to display a partial enlarged schematic diagram corresponding to the human body part, such as a blood vessel, or other human tissue and human cell other than the blood vessel and the like. For example, the operation area 202 is used to display the blood vessel 11, based on the selection operation of the blood vessel 11, an operation position point of the selection operation is identified by the first positioning identification 121 and the second positioning identification 122.

The operation area 201 includes a cross line for positioning, the cross line consists of a first identification line 221 and a second identification line 222. A position positioned by the cross line is consistent with 2D coordinates of the positioning point in the operation area 202, and there is a spatial correspondence relationship in the 3D space. For example, a center position of a circle in the 2D plane is a center positioning point of a sphere in the corresponding 3D space.

Since there are correspondence relationships between the original 2D image and the plurality of 3D reconstruction images for any one positioning point in the spatial positioning and reconstruction process, the positions corresponding to the positioning point in the plurality of operation areas can be obtained according to the correspondence relationships (for example, the correspondence relationship between the 3D stereoscopic image of the blood vessel in the operation area 202 and the 2D cross section of the blood vessel in the operation area 201). Therefore, according to the embodiment of the present disclosure, the interactive objects corresponding to the operation areas can be respectively displayed in the positions corresponding to the plurality of operation areas, and the position changes of the interactive objects, which are caused due to tracking of the positioning point, in the plurality of operation areas are displayed in an interlocking way.

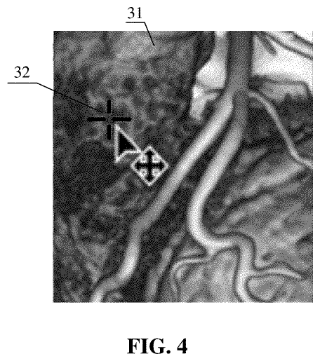

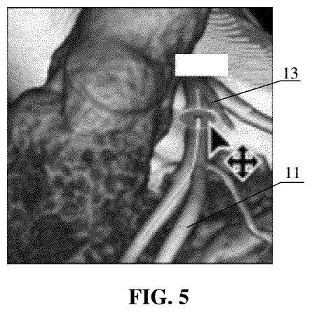

According to the embodiment of the present disclosure, it is also possible to indicate the positioning point with different interactive objects at positions of the positioning point in different operation areas. FIG. 4 and FIG. 5 show schematic diagrams of interactive objects displayed at different positions in operation areas according to an embodiment of the present disclosure. As shown in FIG. 4, a human body part (such as a heart) is displayed in the operation area 203 and the positioning point is at a position outside a blood vessel, such as a human body tissue position of a non-blood vessel on the heart, then positions corresponding to the positioning point in the multiple operation areas may be obtained according to correspondence relationships between the original 2D image and the plurality of 3D reconstruction images for any positioning point, such as the correspondence relationship between the 3D stereoscopic image of the heart in the operation area 203 and the cross-section of the heart in the operation area 201; furthermore, in a case where the position of the positioning point in the operation area 203 is a human body tissue position 31 outside the blood vessel, an interactive object 32 may be displayed, and the interactive object may be a cross.

As shown in FIG. 5, a human body part (such as a heart) is displayed in the operation area 203, and the positioning point is located inside the blood vessel, then positions corresponding to the positioning point in the multiple operation areas may be obtained according to the correspondence relationships between the original 2D image and the plurality of 3D reconstruction images for any positioning point, such as the correspondence relationship between the 3D stereoscopic image of the heart in the operation area 203 and the cross-section of the heart in the operation area 201; and in the case where the position of the positioning point in the operation area 203 is the blood vessel 11, an interactive object 13 may be displayed, and the interactive object may be a “flat cylindrical”. That is to say, the interactive object display mode corresponding to the operation area may vary according to the correspondence relationship between the 3D stereoscopic image of the heart in the operation area 203 and the cross-section of the heart in the operation area 201. For example, as shown in FIG. 4, the positioning point is outside the blood vessel and the interactive object may be displayed as a cross. As shown in FIG. 5, the positioning point is inside the blood vessel and the interactive object may be displayed as a flat cylinder.

According to the embodiment of the present disclosure, the interactive object displayed at the position corresponding to the positioning point in each of the plurality of operation areas can be obtained according to the correspondence relationships between the plurality of operating areas with respect to the positioning point after the positioning point is obtained. Therefore, the positions corresponding to the positioning point in the plurality of operation areas can be synchronized according to the correspondence relationships between the plurality of operating areas with respect to the positioning point, so that the interactive object can be displayed at the corresponding positions. Through the correspondence matching of the spatial positioning and the intuitive display mode, the spatial positioning of the target object and the positioning point in the plurality of operation areas can be timely fed back to the user for viewing. In this way, the user can check and view the same positioning point by using the multiple operation areas, and can intuitively obtain different interactive display states, thereby not only the display feedback effect is improved, but also the next expected processing can be timely performed by the user according to the display feedback effect, and the interactive feedback speed is improved.

As shown in FIG. 3, the operation area 201 also includes an operation menu 21 that can be triggered by a right mouse button, an operation tool pattern “cross” 23 located on the second identification line 222 for a moving operation, and an operation tool pattern “semicircle” for rotation operation. Through the operation menu and each operation tool pattern, a corresponding operation process can be executed by clicking directly, without the need to enter the next operation process after an additional switching process among a plurality of operation processes, thereby the user operation is simplified and the interactive feedback speed is improved.

In a possible implementation, the method further includes: after the interactive object displayed at the position corresponding to the positioning point in each of the plurality of operation areas is obtained, a relative positional relationship between the positioning point and the target object is obtained in response to a position change of the positioning point; and a display state of the interactive object is adjusted according to the relative positional relationship.

The position change of the positioning point may be that the positioning point is changed from inside the target object to outside the target object, that the positioning point is changed from outside the target object to inside the target object, or that the positioning point is always located outside the target object, but the relative angle, the relative distance, or the relative direction between the positioning point and the target object changes.

For example, when the target object is a blood vessel, the relative position includes: the positioning point is in the blood vessel, or the positioning point is out of the blood vessel to the outside of the blood vessel (in this case, the positioning point may be on other human tissues other than the blood vessel). Because the obtained interactive objects are different due to different position relationships, the display state of the interactive object needs to be adjusted. In an example, after the target object is recognized and the position of the positioning point and its position change are determined, then different correspondence relationship representations can be displayed in real time according to the position of the positioning point from the target object (such as a blood vessel) to adjust the display state of the interactive object. The display effects of the interactive object after the display state is adjusted are as shown in FIG. 4 and FIG. 5. For example, in an application scenario, when the positioning point is moved from the inside of the blood vessel to the outside of the blood vessel, the previous first display state (the positioning point is inside of the blood vessel) is “flat cylindrical”; the position change of the positioning point that is tracked is that the positioning point is out of the blood vessel, then the first display state can be adjusted to the second display state (the positioning point is outside of the blood vessel) in real time, and the second display state is a cross.

In a possible implementation, the operation that the display state of the interactive object is adjusted according to the relative positional relationship includes: in response to the relative positional relationship being a first position relationship, the display state of the interactive object is adjusted into an interactive display state that has at least one of following relationships with the target object: angle, direction, displacement, and visual effect.

The first positional relationship may be that the positioning point is always located outside the target object, but the relative angle, the relative distance, or the relative direction between the positioning point and the target object changes.

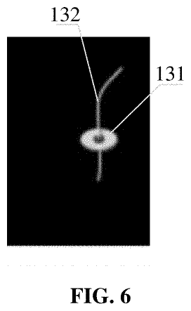

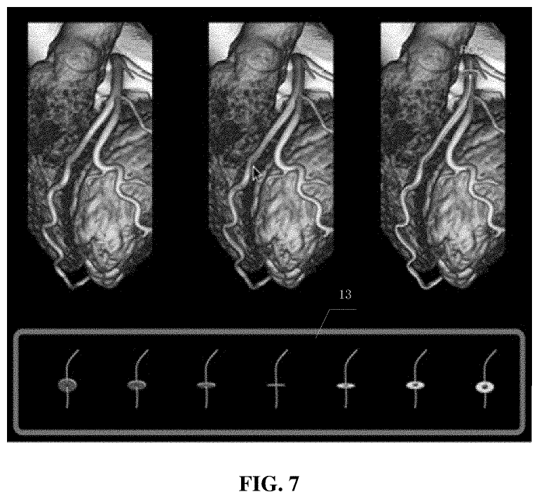

In an example, FIG. 6 shows a partially enlarged schematic diagram of an interactive object in the shape of a flat cylinder according to an embodiment of the present disclosure. As shown in FIG. 6, the target object is a blood vessel and the positioning point is inside the blood vessel, then the interactive object 13 includes a ring 131 on the flat cylinder and a line segment 132 identifying the shape of the blood vessel, where the line segment 132 penetrates the ring 131 in the middle region of the flat cylinder. FIG. 7 shows a schematic diagram showing a change in shape of the interactive object that is a flat cylinder according to an embodiment of the present disclosure. As shown in FIG. 7, the angle, the direction, the displacement, the visual effect and the like of the flat cylinder can change in real time after the relative positional relationship changes. For example, the ring 131 on the flat cylinder in the interactive object 13 is made to present interactive display states of different angles, different directions, different displacements and different visual effects with respect to the line segment 132 identifying the shape of the blood vessel.

In a possible implementation, the display state of the interactive object is adjusted according to the relative positional relationship includes: in response to the relative positional relationship being a second position relationship, the display state of the interactive object is adjusted into an interactive display state indicating a position of the positioning point in the target object.

The second positional relationship may be that the positioning point is changed from inside the target object to outside the target object, or that the positioning point is changed from outside the target object to inside the target object.

In an example, the interactive display state includes: a cross obtained by lateral and longitudinal positioning identifications in the case where the target object is other non-vascular human body part, other non-vascular human tissue, or other non-vascular human cell, as shown in FIG. 4.

### Application Examples

As shown in FIG. 3, after a blood vessel 11 is selected, all displayed contents in each operation area (i.e., operation area 201-operation area 203) pane are synchronously switched to the display view for the vessel. In FIG. 3, a position corresponding to the positioning point identified by the first positioning identification 121 and the second positioning identification 122 in the operation area 202, and a position on the 3D cardiac vessel is correspondingly displayed in the operation area 203. The interactive object is displayed according to the correspondence relationship of the two operation areas, for example, a stereoscopic “flat cylinder” is displayed in the 3D image in the operation area 203 corresponding to the position of the positioning point, and the interactive object “flat cylinder” can be dragged by a mouse in the blood vessel, or can be dragged out of the blood vessel. When the “flat cylinder” is dragged out of the blood vessel, a correspondence relationship is established with the operation area 201, at this time, as shown in FIGS. 4 to 5, the previous positioning point is inside the blood vessel, and the display state of the interactive object is a flat cylindrical; when the positioning point is dragged out of the blood vessel, and the display state of the interactive object is adjusted to be a cross to represent other areas (such as other non-vascular human tissue), so that the positioning point that is dragged to different areas can be tracked to change the display state of the corresponding interactive object. As shown in FIG. 7, in the case where the positioning point is inside the blood vessel, during movement of the mouse on the blood vessel, the flat cylindrical changes in real time according to the positional relationship of the positioning point with respect to the blood vessel. That is, during movement of the flat cylindrical dragged by the mouse on the blood vessel, the interactive display state that has a relationship of at least one of the angle, the direction, the displacement, and the visual effect of the flat cylindrical relative to the blood vessel is displayed in real time.

In the case of medical images related to, for example, a cardiac vessel, or a scene in which the 2D plane has a correspondence relationship with the 3D stereo model in terms positioning, it is necessary to match the points or contents on the 2D plane to the positions of the 3D stereo model, and there are some parts in which the contents need to be moved in a fixed way, for example, the movement is limited to be on the vessel, or on the trachea or on other objects, so that a synchronized matching position relationship will be seen by using the technical.

In the related art, a matching relationship between a point in a 2D plane and a point in a 3D stereoscopic model is realized, but a specific operation mode and an operable language are not provided for different parts, so that a usable operation expectation cannot be well provided to a user, and specific content corresponding to the position cannot be expressed in an intuitionistic way.

The method for interactive display of image positioning described in one or more embodiments of the present disclosure is illustrated by way of example below.

The technical solutions according to embodiments of the present disclosure can be applied to the process of searching for vascular lesions. A physician needs to perform a diagnosis of a patient by viewing the vessel one by one. Through the technical solutions of the present disclosure, it is possible to automatically recognize all blood vessels, sub-vascular lesions, and information of plaque attributes based on an Artificial Intelligence (AI) algorithm. In the confirmation process, the original 2D image and the reconstructed 3D image need to be viewed correspondingly; after a certain blood vessel is selected on the 3D image and a pointer of the blood vessel is moved on the blood vessel of the planar image (i.e., the original 2D image), and the movement of the point will be displayed on the 3D image correspondingly. It is also possible to view the blood vessel, switch between blood vessels and move the control point on the blood vessel on the 3D image, the image correspondence relationship of the control point can be seen in real time, and the control point can be moved to other region of interest in other tissues.

Assuming that the physician selects a blood vessel, as shown in FIG. 3, all contents of the panes (i.e., the operation area 201 to operation area 203) are switched to the blood vessel synchronously. The operation area 201 may be an original 2D image, the operation area 202 and the operation area 203 may be respectively 3D reconstructed images, the operation area 203 may be used to display a global schematic diagram of a human body part, and the operation area 202 may be used to display a partial enlarged schematic diagram corresponding to the human body part. The pointer position (the positioning point identified by the first positioning identification 121 and the second positioning identification 122) on the rightmost (operation area 202) corresponds to the position on the 3D cardiac vessel at the lower left side (operation area 203), when the correspondence relationship between the two panes (operation area 202 and operation area 203) is satisfied, what displayed at the corresponding position on the 3D image is a stereoscopic flat cylinder that can be dragged by the mouse within the vessel or can be dragged out of the vessel. If the flat cylinder is dragged out of the vessel, a matching relationship is established with another image (operation area 201). In this case, as shown in FIG. 4 and FIG. 5, the corresponding point position becomes a cross point, indicating the non-vascular region. What displayed changes in real time as the mouse pointer is dragged to different areas. As shown in FIG. 7, when the positioning point is on the blood vessel, according to the control positional relationship of the heart, the flat cylinder changes its relative spatial positional relationship, including a horizontal and vertical angle and a visual effect, during movement on the blood vessel.

In the embodiments of the present disclosure, it is possible to recognize and embody the 3D spatial position relationship, adjust the operation representation of the corresponding part in real time, and display different corresponding relationship representations in real time according to the positions of different parts, feedback in real time, and instruct other expected operations of the user; and the operability of the part is represented in an vivid way, and the relative spatial relationship and the 3D spatial relationship are well reflected to ease user's understanding.

In the embodiments of the present disclosure, it is possible to recognize body parts and adjust the operation form in real time, whereas in the related art, the form of the operation is fixed and remains the same for different body parts. In the embodiments of the present disclosure, it is possible to vary the angle of the flat cylinder in real time according to the spatial positional relationship of the body tissues, whereas in the related art, the body part is displayed in a fixed form, such as a point.

According to the embodiments of the present disclosure, it is possible to display different corresponding relationship representations in real time according to the positions of different parts, feedback in real time, and instruct other expected operations of the user; and the operability of the part is represented in an vivid way, and the relative spatial relationship and the 3D spatial relationship are well reflected to accelerate the disease search by a doctor, and ease user's understanding.

The embodiments of the present disclosure may be applied to all logical operations having a correspondence relationship such as a scanning workstation such as an imaging department reading system, a Computed Tomography (CT), an Magnetic Resonance (MR), a positron emission tomography (PET), an AI-assisted diagnosis, an AI labeling system, a telemedicine diagnosis, a cloud platform-assisted intelligent diagnosis, and the like.

It can be understood that in the above method of embodiments, the order in which the steps are written does not imply a strict order of execution to constitutes any limitation on the implementation process, and the specific implementation modes, the specific execution sequence of each step may be determined in terms of the function and possible internal logic.

The method embodiments mentioned in the disclosure may be combined with each other to form a combined embodiment without departing from the principle and logic, which is not elaborated in the embodiments of the disclosure for the sake of simplicity.

In addition, the disclosure further provides an image processing apparatus, an electronic device, a computer readable storage medium and a program, all of which may be configured to implement any image processing method provided by the disclosure . The corresponding technical solutions and descriptions refer to the corresponding descriptions in the method and will not elaborated herein.

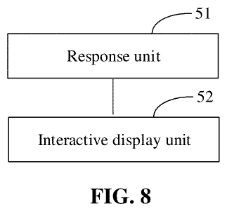

FIG. 8 shows a block diagram of a device for interactive display of image positioning according to an embodiment of the present disclosure. As shown in FIG. 8, the device includes: a response unit 51, configured to obtain a positioning point in response to a selection operation of a target object; and an interactive display unit 52, configured to obtain an interactive object displayed at a corresponding position of the positioning point in each of the plurality of operation areas according to the correspondence relationships between the plurality of operating areas with respect to the positioning point.

In a possible implementation, the interactive display unit is configured to:

In the case where the plurality of operation areas respectively represent a 2D image and a 3D image, obtain the position corresponding to the positioning point in each of the plurality of operation areas according to a correspondence relationship of the positioning point in the 2D image and the 3D image;

and display the interactive objects interlocking between the plurality of operation areas at the positions corresponding to the positioning point in the plurality of operation areas.

In a possible implementation, the response unit is configured to obtain a relative positional relationship between the positioning point and the target object in response to the position change of the positioning point;

and interactive display unit is configured to adjust the display state of the interactive object according to the relative positional relationship.

In a possible implementation, the interactive display unit is configured to:

in response to the relative positional relationship being a first position relationship, adjust the display state of the interactive object into an interactive display state that has at least one of following relationships with the target object: angle, a direction, displacement, and visual effect.

In a possible implementation, the interactive display unit is configured to:

in response to the relative positional relationship being a second position relationship, adjust a display state of the interactive object into an interactive display state indicating a position of the positioning point in the target object.

In a possible implementation, the device further includes an recognition unit, configured to:

obtain a feature vector of the target object;

recognize the target object according to the feature vector and a recognition network.

In some embodiments, the function or included module of the apparatus provided by the embodiment of the present disclosure may be configured to execute the method described in the above method embodiments, and the specific implementation may refer to the description in the above method embodiments. For the simplicity, the details are not elaborated herein.

The embodiments of the disclosure further provide a computer-readable storage medium, in which a computer program instruction is stored, the computer program instruction being executed by a processor to implement the above any image processing method. The computer-readable storage medium may be a non-volatile computer-readable storage medium.

An embodiment of the present disclosure also provides a computer program product including computer-readable code, under the condition that the computer readable code runs on a device, a processor in the device executes instructions for implementing the method for interactive display of image positioning as provided in any one of the above embodiments.

The embodiments of the present disclosure also provide another computer program product, configured to store computer readable instructions, when being executed, cause a computer to perform operations of the method for interactive display of image positioning provided in any one of the above embodiments.

The computer program product may be implemented in hardware, software, or a combination thereof. In an alternative embodiment, the computer program product is embodied as a computer storage medium, and in another alternative embodiment, the computer program product is embodied as a software product, such as a Software Development Kit (SDK) and the like.

An embodiment of the present disclosure further provides an electronic device, including a processor; a memory, configured to store instructions executable by the processor; and the processor is configured to implement the method as described above.

The electronic device may be provided as a terminal, a server, or other form of device.

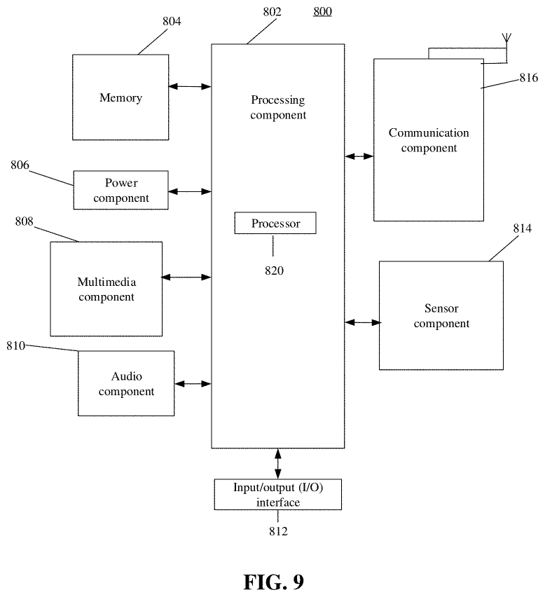

FIG. 9 is a block diagram of an electronic device 800 according to an embodiment of the present disclosure. For example, the electronic device 800 may be a terminal such as a mobile phone, a computer, a digital broadcast terminal, a messaging device, a game console, a tablet device, a medical device, an exercise device, a personal digital assistant and the like.

Referring to FIG. 9, the electronic device 800 may include one or more of the following components: a processing component 802, a memory 804, a power component 806, a multimedia component 808, a audio component 810, an Input/Output (I/O) interface 812, a sensor component 814, and a communication component 816.

The processing component 802 typically controls the overall operations of the electronic device 800, such as operations associated with display, telephone calls, data communications, camera operations, and recording operations. The processing component 802 may include one or more processors 820 to execute instructions to perform all or part of the steps in the above described methods. Moreover, the processing component 802 may include one or more modules which facilitate the interaction between the processing component 802 and other components. For instance, the processing component 802 may include a multimedia module to facilitate the interaction between the multimedia component 808 and the processing component 802.

The memory 804 is configured to store various types of data to support the operation of the electronic device 800. Examples of such data include instructions for any disclosure or method operated on the electronic device 800, contact data, phone book data, messages, pictures, video, etc. The memory 804 may be implemented by any type of volatile or non-volatile memory devices, or a combination thereof, such as a Static Random Access Memory (SRAM), an Electrically Erasable Programmable read only memory (EEPROM), an Erasable Programmable Read-Only Memory (EPROM), a Programmable Read-Only Memory (PROM), a Read-Only Memory (ROM), a magnetic memory, a flash memory, a magnetic disk, or optical disk.

The power component 806 provides power to various components of electronic device 800. The power component 806 may include a power management system, one or more power sources, and other components associated with generation, management, and distribution of power in the electronic device 800.

The multimedia component 808 includes a screen providing an output interface between the electronic device 800 and a user. In some embodiments, the screen may include a Liquid Crystal Display (LCD) and a Touch panel (TP). If the screen includes the TP, the screen may be implemented as a touch screen to receive input signals from a user. The TP includes one or more touch sensors to sense touch, swipes, and gestures on the TP. The touch sensor may not only sense the boundary of a touch or swipe action, but also sense a period of time and a pressure associated with the touch or swipe action. In some embodiments, the multimedia component 808 includes a front camera and/or a rear camera. The front camera and/or the rear camera may receive external multimedia data when the electronic device 800 is in an operation mode, such as a photographing mode or a video mode. Each of the front camera and the rear camera may be a fixed optical lens system or have focus and optical zoom capability.

The audio component 810 is configured to output and/or input audio signals. For example, the audio component 810 includes a microphone (MIC) configured to receive an external audio signal when the electronic device 800 in an operating mode, such as a call mode, a recording mode, and a voice recognition mode. The received audio signal may further be stored in memory 804 or transmitted via the communication component 816. In some embodiments, the audio component 810 further includes a speaker, configured to output an audio signal.

The I/O interface 812 provides an interface between the processing component 802 and peripheral interface modules. The peripheral interface modules may be a keyboard, a click wheel, buttons, and the like. The buttons may include, but are not limited to, a home page button, a volume button, a starting button, and a locking button.

The sensor component 814 includes one or more sensors to provide status assessments of various aspects of the electronic device 800. For instance, the sensor component 814 may detect an on/off state of the electronic device 800 and relative positioning of the components, such as a display and small keyboard of the electronic device 800, and the sensor component 814 may further detect a change in a position of the electronic device 800 or a component of the electronic device 800, the presence or absence of contact between the user and the electronic device 800, orientation or acceleration/deceleration of the electronic device 800 and a change in temperature of the electronic device 800. The sensor component 814 may include a proximity sensor, configured to detect the presence of nearby objects without any physical contact. The sensor component 814 may also include a light sensor, such as a Complementary Metal Oxide Semiconductor (CMOS) or Charge-coupled Device (CCD) image sensor, configured for use in an imaging disclosure. In some embodiments, the sensor component 814 may also include an accelerometer sensor, a gyroscope sensor, a magnetic sensor, a pressure sensor, or a temperature sensor.

The communication component 816 is configured to facilitate wired or wireless communication between the electronic device 800 and other devices. The electronic device 800 may access a communication-standard-based wireless network, such as WiFi, 2-Generation wireless telephone technology (2G) or 3-Generation wireless telephone technology (3G) or a combination thereof. In one exemplary embodiment, the communication component 816 receives broadcast signals or broadcast information from an external broadcast management system via a broadcast channel In one exemplary embodiment, the communication component 816 further includes a Near Field Communication (NFC) module to facilitate short-range communications. For example, the NFC module may be implemented based on a Radio Frequency Identification (RFID) technology, an Infrared Data Association (IrDA) technology, an Ultra Wide Band (UWB) technology, a Bluetooth (BT) technology, and other technologies.

In an exemplary embodiment, the electronic device 800 may be implemented by one or more Application Specific Integrated Circuit (ASICs), Digital Signal Processing (DSPs), Digital Signal Processing Devices (DSPDs), Programmable Logic Devices (PLD), Field Programmable Gate Arrays (FPGAs), controllers, microcontrollers, microprocessors, or other electronic components, and is configured to execute the above method.

In an exemplary embodiment, a non-volatile computer-readable storage medium, for example, a memory 804 including a computer program instruction, is also provided. The computer program instruction may be executed by a processor 820 of the electronic device 800 to implement the above method.

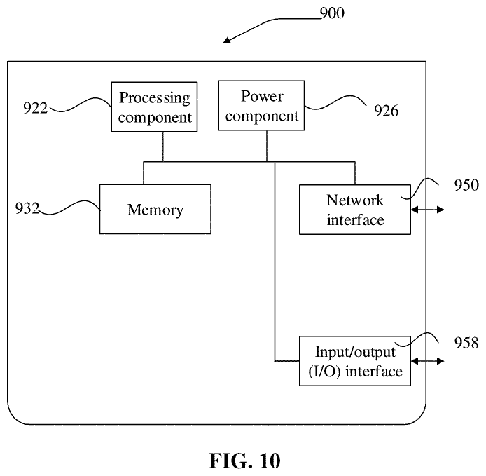

FIG. 10 is a block diagram of an electronic device 900 according to an embodiment of the disclosure. For example, the electronic device 900 may be provided as a server. Referring to FIG. 10, the electronic device 900 includes a processing component 922, further including one or more processors, and a memory resources represented by a memory 932, configured to store an instruction executable for the processing component 922, for example, an application program. The application program stored in memory 932 may include one or more modules, with each module corresponding to one group of instructions. In addition, the processing component 922 is configured to execute the instruction to execute the above method.

The electronic device 900 may further include a power component 926 is configured to execute power management of the electronic device 900, a wired or wireless network interface 950 configured to connect the electronic device 900 to a network and an input/output (I/O) interface 958. The electronic device 900 may be operated based on an operating system stored in the memory 932, for example, Windows Server™, Mac OS X™, Unix™, Linux™, FreeBSD™ and the like.

In an exemplary embodiment, a non-volatile computer-readable storage medium for example, a second memory 1932 including a computer program instruction, is also provided. The computer program instruction may be executed by a processing component 922 of an electronic device 900 to implement the above method.

The present disclosure may be a system, a method and/or a computer program product. The computer program product may include a computer-readable storage medium, in which a computer-readable program instruction configured to enable a processor to implement each aspect of the present disclosure is stored.

The computer-readable storage medium may be a physical device capable of retaining and storing an instruction used by an instruction execution device. The computer-readable storage medium may be, but not limited to, an electrical storage device, a magnetic storage device, an optical storage device, an electromagnetic storage device, a semiconductor storage device or any suitable combination thereof. More specific examples (non-exhaustive list) of the computer-readable storage medium include a portable computer disk, a hard disk, a Random Access Memory (RAM), a read-only memory (ROM), an erasable programmable read-only memory (EPROM or flash memory), a static random access memory (SRAM), a Compact Disc Read-Only Memory (CD-ROM), a Digital Video Disc (DVD), a memory stick, a floppy disk, a mechanical coding device, a punched card or in-slot raised structure with an instruction stored therein, and any appropriate combination thereof. Herein, the computer-readable storage medium is not explained as an transient signal, for example, a radio wave or another freely propagated electromagnetic wave, an electromagnetic wave propagated through a wave guide or another transmission medium (for example, a light pulse propagated through an optical fiber cable) or an electric signal transmitted through an electric wire.

The computer-readable program instruction described here may be downloaded from the computer-readable storage medium to various computing/processing device or downloaded to an external computer or an external storage device through a network such as an Internet, a local area network, a wide area network, and/or a wireless network. The network may include a copper transmission cable, a fiber optic transmission cable, a wireless transmission cable, a router, a firewall, a switch, a gateway computer and/or an edge server. A network adapter card or network interface in each computing/processing device receives the computer-readable program instruction from the network and forwards the computer-readable program instruction for storage in the computer-readable storage medium in each computing/processing device.

The computer program instruction f configured to execute the operations of the present disclosure may be an assembly instruction, an Industry Standard Architecture (ISA) instruction, a machine instructions, machine-related instruction, a microcode, a firmware instruction, state setting data or a source code or target code edited by one or any combination of more programming languages, the programming language including an object-oriented programming languages such as Smalltalk and C++ and a conventional procedural programming language such as “C” language or a similar programming language. The computer-readable program instruction may be completely or partially executed in a computer of a user, executed as an independent software package, executed partially in the computer of the user and partially in a remote computer, or executed completely in the remote server or a server. In a case involved in the remote computer, the remote computer may be connected to the user computer via any type of network including the local area network (LAN) or the Wide Area Network (WAN), or may be connected to an external computer (such as using an Internet service provider to provide the Internet connection). In some embodiments, an electronic circuit such as a programmable logic circuit, a field programmable gate array (FPGA), or a programmable logic array (PLA), is customized by using state information of the computer-readable program instruction to implement each aspect of the present disclosure.

Herein, each aspect of the embodiments of the present disclosure is described with reference to flowcharts and/or block diagrams of method, device (systems) and computer program product in according to the embodiments of the present disclosure. It is to be understood that each block in the flowcharts and/or block diagrams and a combination of each block in the flowcharts and/or block diagrams may be implemented by computer-readable program instructions.

The computer-readable program instructions may be provided for a universal computer, a dedicated computer or a processor of another programmable data processing device, thereby generating a machine to further generate a device that realizes a function/action specified in one or more blocks in the flowcharts and/or the block diagrams when the instructions are executed through the computer or the processor of the other programmable data processing device. These computer-readable program instructions may also be stored in a computer-readable storage medium, and through these instructions, the computer, the programmable data processing device and/or another device may work in a specific manner, so that the computer-readable medium including the instructions includes a product including instructions for implementing each aspect of the function/action specified in one or more blocks in the flowcharts and/or the block diagrams.

The computer-readable program instructions may further be loaded to the computer, the other programmable data processing device or other device, so that a series of operating steps are executed in the computer, the other programmable data processing device or other device to generate a process implemented by the computer to further realize the function/action specified in one or more blocks in the flowcharts and/or the block diagrams by the instructions executed in the computer, the other programmable data processing device or the other device.

The flowcharts and block diagrams in the drawings illustrate probably implemented system architectures, functions, and operations of the systems, method, and computer program product according to multiple embodiments of the present disclosure. On this aspect, each block in the flowcharts or block diagrams may represent part of a module, a program segment or an instruction, and part of the module, the program segment or the instruction includes one or more executable instructions configured to realize a specified logical function. In some alternative implementations, the functions marked in the blocks may also be realized in a sequence different from those marked in the drawings. For example, two continuous blocks may actually be executed in a substantially concurrent manner and may also be executed in a reverse sequence sometimes, which is determined by the involved functions. It is further to be noted that each block in the block diagrams and/or flowcharts and a combination of the blocks in the block diagrams and/or the flowcharts may be implemented by a dedicated hardware-based system configured to execute a specified function or operation or may be implemented by a combination of a special hardware and a computer instruction.

Various embodiments of the present disclosure may be combined with each other without departing from the logic, the description of the various embodiments being focused, and reference may be made to the description of other embodiments for the description of the various embodiments.

Each embodiment of the present disclosure has been described above. The above descriptions are exemplary, non-exhaustive, and also not limited to each disclosed embodiment. Many modifications and variations are apparent to those of ordinary skill in the art without departing from the scope and spirit of each described embodiment of the present disclosure. The terms used herein are selected to explain the principles and practical application of each embodiment or technical improvements in the technologies in the market best or enable others of ordinary skill in the art to understand the each embodiment disclosed herein.

### INDUSTRIAL DISCLOSURE

In the embodiments of the present disclosure, through the correspondence matching of the spatial positioning and the intuitive display mode, the spatial positioning of the target object and the positioning point in a plurality of operation areas can be timely fed back to the user for viewing, which not only improves the display feedback effect, but also enables the user to perform the next expected processing in time according to the display feedback effect, thereby the interactive feedback speed is improved.

1. A method for interactive display of image positioning, comprising:
obtaining a positioning point in response to a selection operation of a target object; and
obtaining an interactive object displayed at a position corresponding to the positioning point in each of a plurality of operation areas according to correspondence relationships between the plurality of operation areas with respect to the positioning point.

2. The method of claim 1, wherein obtaining the interactive object displayed at the position corresponding to the positioning point in each of the plurality of operation areas according to the correspondence relationships between the plurality of operation areas with respect to the positioning point comprises:
in a case where the plurality of operation areas respectively represent a two-dimensional (2D) image and a three-dimensional (3D) image, obtaining the position corresponding to the positioning point in each of the plurality of operation areas according to a correspondence relationship of the positioning point in the 2D image and the 3D image; and
displaying, at the positions corresponding to the positioning point in the plurality of operation areas, the interactive objects interlocking between the plurality of operation areas.

3. The method of claim 1, further comprising: after obtaining the interactive object displayed at the position corresponding to the positioning point in each of the plurality of operation areas,
obtaining a relative positional relationship between the positioning point and the target object in response to a position change of the positioning point; and
adjusting a display state of the interactive object according to the relative positional relationship.

4. The method of claim 3, wherein adjusting the display state of the interactive object according to the relative positional relationship comprises:
in response to the relative positional relationship being a first positional relationship, adjusting the display state of the interactive object into an interactive display state that has at least one of following relationships with the target object: angle, direction, displacement, and visual effect.

5. The method of claim 3, wherein adjusting the display state of the interactive object according to the relative positional relationship comprises:
in response to the relative positional relationship being a second positional relationship, adjusting the display state of the interactive object into an interactive display state indicating a position of the positioning point in the target object.

6. The method of claim 1, further comprising: before obtaining the positioning point in response to the selection operation of the target object,
obtaining a feature vector of the target object; and
recognizing the target object according to the feature vector and a recognition network.

7. The method of claim 2, further comprising: before obtaining the positioning point in response to the selection operation of the target object,
obtaining a feature vector of the target object; and
recognizing the target object according to the feature vector and a recognition network.

8. A device for interactive display of image positioning, comprising:
a memory storing processor-executable instructions; and
a processor configured to execute the processor-executable instructions to perform operations of:
obtaining a positioning point in response to a selection operation of a target object; and
obtaining an interactive object displayed at a position corresponding to the positioning point in each of a plurality of operation areas according to correspondence relationships between the plurality of operation areas with respect to the positioning point.

9. The device of claim 8, wherein obtaining the interactive object displayed at the position corresponding to the positioning point in each of the plurality of operation areas according to the correspondence relationships between the plurality of operation areas with respect to the positioning point comprises:
in a case where the plurality of operation areas respectively represent a two-dimensional (2D) image and a three-dimensional (3D) image, obtaining the position corresponding to the positioning point in each of the plurality of operation areas according to a correspondence relationship of the positioning point in the 2D image and the 3D image; and
displaying, at the positions corresponding to the positioning point in the plurality of operation areas, the interactive objects interlocking between the plurality of operation areas.

10. The device of claim 8, wherein the processor is configured to execute the processor-executable instructions to further perform operations of: after obtaining the interactive object displayed at the position corresponding to the positioning point in each of the plurality of operation areas,
obtaining a relative positional relationship between the positioning point and the target object in response to a position change of the positioning point; and
adjusting a display state of the interactive object according to the relative positional relationship.

11. The device of claim 10, wherein adjusting the display state of the interactive object according to the relative positional relationship comprises:
in response to the relative positional relationship being a first positional relationship, adjusting the display state of the interactive object into an interactive display state that has at least one of following relationships with the target object: angle, direction, displacement, and visual effect.

12. The device of claim 10, wherein adjusting the display state of the interactive object according to the relative positional relationship comprises:
in response to the relative positional relationship being a second positional relationship, adjusting the display state of the interactive object into an interactive display state indicating a position of the positioning point in the target object.

13. The device of claim 8, wherein the processor is configured to execute the processor-executable instructions to further perform operations of: before obtaining the positioning point in response to the selection operation of the target object,
obtaining a feature vector of the target object; and
recognizing the target object according to the feature vector and a recognition network.

14. The device of claim 9, wherein the processor is configured to execute the processor-executable instructions to further perform operations of: before obtaining the positioning point in response to the selection operation of the target object,
obtaining a feature vector of the target object; and
recognizing the target object according to the feature vector and a recognition network.

15. A non-transitory computer storage medium having stored thereon computer-readable instructions that, when executed by a processor, cause the processor to perform operations of a method for interactive display of image positioning, the method comprising:
obtaining a positioning point in response to a selection operation of a target object; and
obtaining an interactive object displayed at a position corresponding to the positioning point in each of a plurality of operation areas according to correspondence relationships between the plurality of operation areas with respect to the positioning point.

16. The non-transitory computer storage medium of claim 15, wherein obtaining the interactive object displayed at the position corresponding to the positioning point in each of the plurality of operation areas according to the correspondence relationships between the plurality of operation areas with respect to the positioning point comprises:
in a case where the plurality of operation areas respectively represent a two-dimensional (2D) image and a three-dimensional (3D) image, obtaining the position corresponding to the positioning point in each of the plurality of operation areas according to a correspondence relationship of the positioning point in the 2D image and the 3D image; and
displaying, at the positions corresponding to the positioning point in the plurality of operation areas, the interactive objects interlocking between the plurality of operation areas.

17. The non-transitory computer storage medium of claim 15, wherein the method further comprises: after obtaining the interactive object displayed at the position corresponding to the positioning point in each of the plurality of operation areas,
obtaining a relative positional relationship between the positioning point and the target object in response to a position change of the positioning point; and
adjusting a display state of the interactive object according to the relative positional relationship.

18. The non-transitory computer storage medium of claim 17, wherein adjusting the display state of the interactive object according to the relative positional relationship comprises:
in response to the relative positional relationship being a first positional relationship, adjusting the display state of the interactive object into an interactive display state that has at least one of following relationships with the target object: angle, direction, displacement, and visual effect.

19. The non-transitory computer storage medium of claim 17, wherein adjusting the display state of the interactive object according to the relative positional relationship comprises:
in response to the relative positional relationship being a second positional relationship, adjusting the display state of the interactive object into an interactive display state indicating a position of the positioning point in the target object.

20. The non-transitory computer storage medium of claim 15, wherein the method further comprises: before obtaining the positioning point in response to the selection operation of the target object,
obtaining a feature vector of the target object; and
recognizing the target object according to the feature vector and a recognition network.
